(19) United States
(12) Patent Application Publication
(10) Pub. No.: US 2024/0240698 A1
(43) Pub. Date: Jul. 18, 2024

(54) BAND REPLACEMENT TOOL

(71) Applicant: Walmart Apollo, LLC, Bentonville, AR (US)

(72) Inventors: Colton Chase Roach, Gentry, AR (US); Myron Dexter Mason, Denton, AR (US); Martin Parkhurst, Rogers, AR (US)

(21) Appl. No.: 18/408,594

(22) Filed: Jan. 10, 2024

Related U.S. Application Data
(60) Provisional application No. 63/479,719, filed on Jan. 12, 2023.

(51) Int. Cl. F16H 7/24

(52) U.S. Cl. CPC F16H 7/24

(57) ABSTRACT

Examples provide a band replacement tool for installing a band around a set of rollers on a conveyor device. The band replacement tool includes a shaft having a minimum threshold length sufficient to reach a lower roller on the conveyor device. The shaft has a maximum threshold width which enables the shaft of the tool to fit between rollers. The shaft is sized to fit within a narrow space between the last roller and the side of the conveyor device. The head of the tool is a concave shape having two side members substantially parallel to each other forming a U-shaped end. The head is sized to partially cup a portion of a band during installation. The handle optionally includes finger grips and is shaped to increase leverage enabling faster installation of the band over the rollers. An opening is optionally disposed within the handle for hanging the tool.

### BACKGROUND

Conveyor devices typically include a set of rollers with a band wrapped around the rollers. Packages or other objects placed on the band are moved down the length of the conveyor as the band is moved by the set of rollers. In some cases, wheel guides help to keep the band in place across the set of rollers. The rollers are turned by a motor. When the band breaks or slips off the rollers, users are required to push the slipped band back into place or put a new band on the rollers. However, it can be difficult to stretch the band back over and around the rollers. Especially as the spaces between the rollers and the conveyor device sides are frequently narrow and difficult to access. Thus, replacing bands on a conveyor device can be a time-consuming and difficult process for users.

### SUMMARY

Some examples provide a band replacement tool for installing a band around a set of rollers on a conveyor device without damaging equipment. The tool includes a shaft that is at least a threshold minimum length. The shaft has a width no wider than a threshold maximum width. The shaft is sized to fit between a roller of the conveyor device and a side member of the conveyor device. The length of the shaft enables the tool to reach down to a lower roller on the conveyor device. The head of the tool includes a concave surface disposed between a first side member and a second side member forming a U-shaped end. The head is sized to cup or partially enclosed a portion of the band during installation of the band around a set of rollers. The size of the head is small enough to fit within a groove for routing the band around the roller of the conveyor device. The gripping member of the tool include a handle. In some examples, the handle includes a set of finger grips. The handle optionally includes an opening for hanging the tool.

This Summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a band replacement tool for fitting a band around a set of rollers on a conveyor.

FIG. 2 is an exemplary block diagram illustrating a perspective view of the band replacement tool having a rectangular-shaped handle associated with the gripping member.

FIG. 3 is an exemplary block diagram illustrating the band replacement tool having a shaft of a minimum threshold length and a maximum threshold width.

FIG. 4 is an exemplary block diagram illustrating the band replacement tool having a T-shaped handle.

FIG. 5 is an exemplary block diagram illustrating the band replacement tool having a cylindrical handle.

FIG. 6 is an exemplary block diagram illustrating an environment for use of the band replacement tool.

FIG. 7 is an exemplary block diagram illustrating a side view of a conveyor device for which a tool, such as a band replacement tool may be used.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Personnel at stores and/or warehouses using conveyor systems often struggle with replacing bands on conveyor devices. In some cases, it takes a human user approximately three minutes on average to replace a band on the conveyor device. This is a time-consuming process. Moreover, users attempting to manually replace the bands frequently are unable to successfully replace the bands, necessitating bringing in specialized technicians to complete the task. Even when successful, users replacing the bands typically require long periods of time to complete the band replacement process.

In some cases, the process of replacing the bands using currently available tools can also result in damage to equipment because available tools do not fit into the narrow gaps between the rollers and sides of the conveyor device. Moreover, users may become injured if their hands slip while attempting to push the bands into place around the rollers. Thus, replacing the bands can be expensive due to costs associated with having technicians to replace the bands, time delays in unloading during band replacement, potential injuries to human users as well as possible damage to equipment which may occur during attempts to replace the bands.

Referring to the figures, examples of the disclosure provide a band replacement tool. In some examples, the tool has a shaft and head sized to fit between rollers on a conveyor device, as well as to fit between the rollers and the sides of the conveyor device. This enables the user to push a band more quickly and easily over and around each roller during the installation process.

In other examples, the shaft of the tool has a length which is long enough to reach down to the bottom of the lower rollers on the conveyor. This enables the user to push the band over every roller in a quick and efficient manner while minimizing the chances of injury to the user.

In still other examples, the tool includes a U-shaped head sized to cup or partially enclose a portion of the band. This enables the user to secure the band on the end of the tool as the user pushes the band into the groove of each roller. This enables easier installation while reducing injuries to users and eliminating damage to rollers and other equipment.

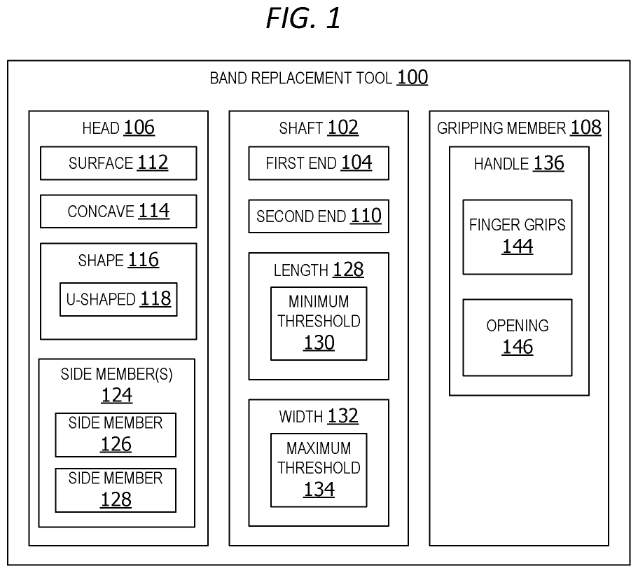

Referring again to FIG. 1, an exemplary block diagram illustrates a band replacement tool 100 for fitting a band around a set of rollers on a conveyor. The band replacement tool 100 includes a shaft 102 having a head 106 at a first end 104 of the shaft 102 and a gripping member 108 at a second end 110 of the shaft. The head 106 has a concave 114 surface 112 sized to cup a portion of a band as the band is installed over a roller in the set of rollers on the conveyor. The shape 116 of the head 106 in some examples is a substantially U-shaped 118 head having a set of side member(s) 124 including a first side member 126 and a second side member 128. The band is positioned between the first side member 126 and the second side member 128 of the band replacement tool 100 during band installation.

In other examples, the head 106 includes the set of side member(s) 124 positioned substantially parallel to each other. The side member(s) 124 form a cup-shape or substantially U-shaped 118 head 106 having a concave 114 surface disposed between the side member(s) 124.

The shaft 102 has a length which is sufficient to enable the band replacement tool 100 to slide between a roller and the side member of the conveyor device. In other examples, the shaft 102 has a length which is sufficient to reach the underside of each roller. In other examples, the length of the shaft is equal to or greater than a minimum threshold length 130. The minimum threshold length 130 is any length sufficient to install the band around one or more rollers on a conveyor. In this example, the minimum threshold length is approximately seven inches long.

The shaft 102 has a width which is thin enough to enable the head and shaft of the band replacement tool 100 to fit between the roller(s) and the roller guides. In other examples, the shaft 102 has a width which is narrow enough to enable the band replacement tool 100 to fit between the side wall of the conveyor device and at least one roller. In other examples, the width 132 is any width that is equal to or less than a maximum threshold 134 width. In this example, the maximum threshold 134 width is three-eighths of an inch.

The gripping member 108 is an end of the band replacement tool 100 which a user grips while utilizing the band replacement tool 100 to install a band on a roller. The gripping member 108 in some examples includes a handle 136. The handle in some examples is substantially T-shaped. In other examples, the handle 136 of the band replacement tool 100 is rectangular shaped. A rectangular shaped handle includes a square shaped handle. In still other examples, the handle is cylindrical.

However, the examples are not limited to a T-shaped, rectangle-shaped, or cylindrical handle. In other examples, the handle 136 is L-shaped, round, oval shaped, hexagonal or any other shaped handle.

The handle 136 optionally includes finger grips 144. The finger grips 144 include one or more indentations or substantially crescent shaped depressions sized to fit one or more fingers of a human user's hand. In this example, the finger grips 144 include four finger grips. In other examples, the finger grips include five finger grips, three finger grips or any other number of finger grips.

The handle 136 in some examples includes an opening 146 for hanging the tool on a hook, nail, or peg, etc. to facilitate storage of the tool. In other examples, the handle optionally includes an adhesive member for sticking the tool on another surface, such as a hook and loop fastener, magnet, or other device for holding the band replacement tool 100 in place during storage. In this example, the opening 146 is a hole in the handle or other portion of the gripping member enabling the band replacement tool 100 to be hung up for storage.

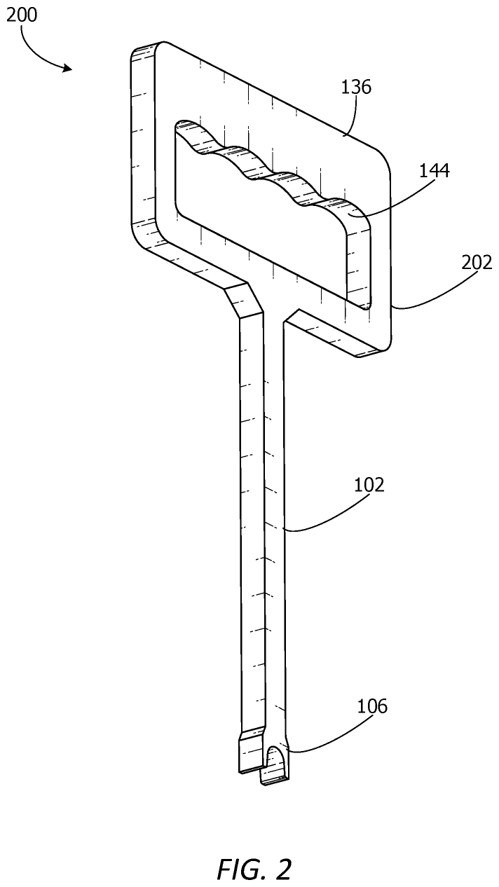

FIG. 2 is an exemplary block diagram illustrating a perspective view of a band replacement tool 200 having a rectangular-shaped handle. The band replacement tool 200 is a tool for replacing a band on roller(s) associated with a conveyor device, such as, but not limited to, the band replacement tool 100 in FIG. 1.

In this example, the handle 136 is a rectangular 202 shape having four sides defining an aperture through which a user inserts fingers to grip the handle 136 during utilization of the band replacement tool 200. The handle 136 includes finger grips 144. The finger grips 144 in this example are disposed along an inner surface, relative to the defined aperture, of a first side of the rectangular 202 handle. The first side is connected to a second perpendicular side and parallel to a third side. The third side connects to a fourth perpendicular side. In this example, the tool accommodates insertion of a user's fingers through the aperture to wrap the fingers of one hand around the handle along the grooves of the finger grips for increased stability and leverage when using the tool to install a band around one or more rollers.

In some examples, the shaft 102 is connected at one end to the handle 136 and connected at the opposite end from the handle 136 to the head 106. In some examples, the head 106 is contiguous with the shaft. The head 106 in this example includes a concave inner surface disposed between two parallel side members forming a substantially U-shaped end to the tool, which enables the tool to cup a portion of a band at least partially during installation of the band.

The shaft 102 in this example is substantially flat or rectangular-shaped, having four flat sides. In other examples, the shaft 102 is a rounded or cylindrical shaft. The shaft 102 has a width that is sized to fit between the rollers, fit between a roller and a side member of the conveyor, and/or reach the underside of a roller.

The handle 136, shaft 102 and head 106 in this example are composed of metal or a composite metal, such as, but not limited to, stainless steel, aluminum, iron, copper, etc. In other examples, the band replacement tool is composed of plastic or any other suitable composite material.

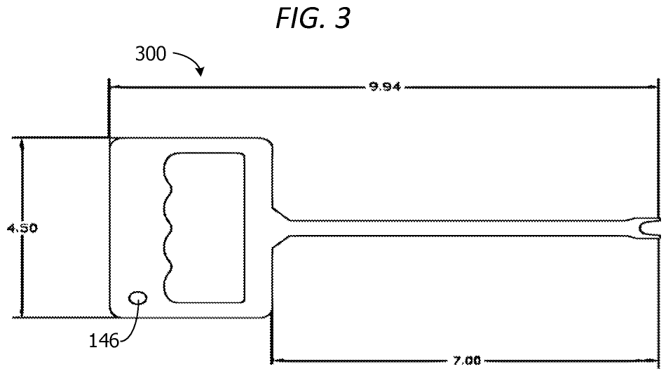

FIG. 3 is an exemplary block diagram illustrating the band replacement tool 300 in one embodiment having a shaft of a minimum threshold length and a maximum threshold width of the shaft. The band replacement tool 300 is a tool, such as, but not limited to, the band replacement tool 100 in FIG. 1. In this example, the band replacement tool 300 includes a shaft that is seven inches long. However, the examples are not limited to a seven inches long tool shaft. In other examples, the shaft is a length that is greater than or less than seven inches long.

The handle, in this example embodiment, is four and a half inches wide. However, the examples are not limited to a four and a half inches wide handle. The handle in other examples is any length and width suitable for enabling a user to grip the tool. The handle 136 optionally includes an opening 146 for hanging the tool from a hook or peg.

In this non-limiting example, the total length of the tool is shown as 9.94 inches long. However, the examples are not limited to a tool that is 9.94 inches long. In other examples, the tool can be any length.

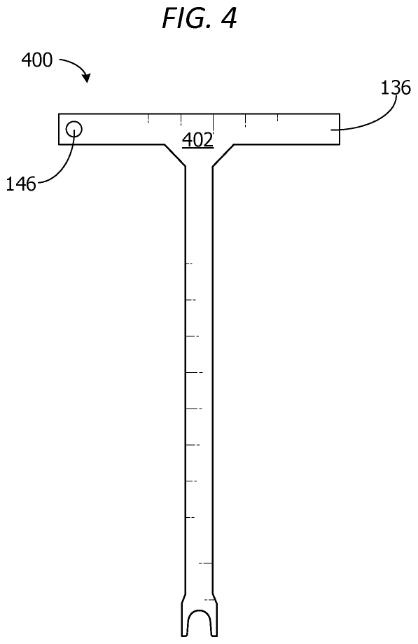

FIG. 4 is an exemplary block diagram illustrating the band replacement tool 400 having a T-shaped 402 handle 136. An opening 146 for hanging the tool is disposed within the handle 136. The band replacement tool 400 is a tool such as, but not limited to, the band replacement tool 100 in FIG. 1.

In some examples, the band replacement tool 400 is stored by hanging the tool on a hook or peg by the opening 146. In this example, the opening is a hole within the handle. The band replacement tool 400 is configured to hang from a hook or peg using the opening 146. Although an opening is illustrated, any other suitable means for removably attaching the tool to a storage surface may be used, such as, but not limited to, a hook, hook and loop fastener, a clip, a clamp, a magnet, or any other type of hanger on the handle for hanging the tool.

The band replacement tool 400 shown in FIG. 4 includes an opening 146 within the T-shaped 402 handle 136. However, in other examples, the T-shaped 402 handle 136 does not include an opening 146.

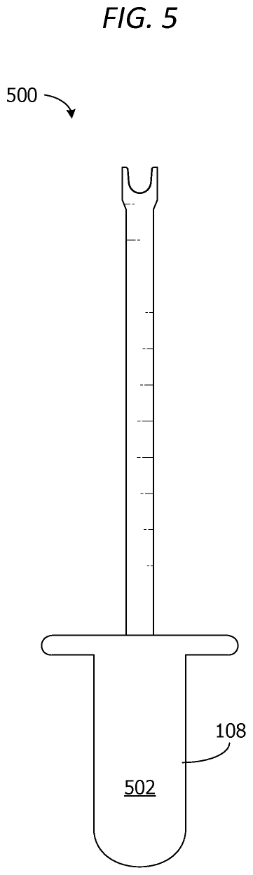

Turning now to FIG. 5, an exemplary block diagram illustrating the band replacement tool 500 having a cylindrical handle is depicted. The band replacement tool 500 is a tool such as, but not limited to, the band replacement tool 100 in FIG. 1. In this example, the gripping member 108 of the tool includes a cylindrical 502 handle. The cylindrical 502 handle optionally includes finger grips and/or an element that allows the tool to be hung from a peg, nail, hook, or the like (not shown).

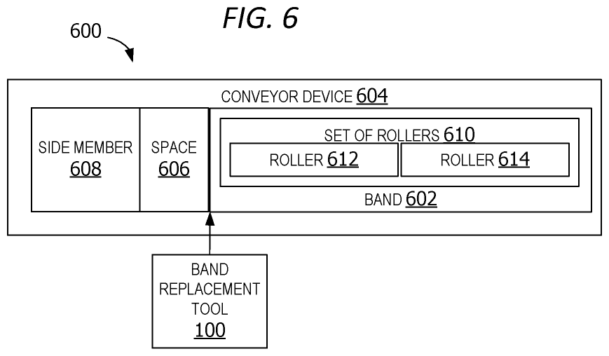

FIG. 6 is an exemplary block diagram illustrating an environment 600 for use of the band replacement tool 100. Environment 600 includes, for example, a band 602 implemented on a conveyor device 604. In this example, the band replacement tool 100 is sized to fit within a space 606 between a side member 608 of the conveyor device 604 and a set of rollers 610 in order to facilitate removal or replacement of band 602 around set of rollers 610. In this example, the set of rollers 610 includes one or more rollers, such as, but not limited to, the roller 612 and the roller 614. However, the set of rollers is not limited to only two rollers. In other examples, the set of rollers 610 includes any number of rollers.

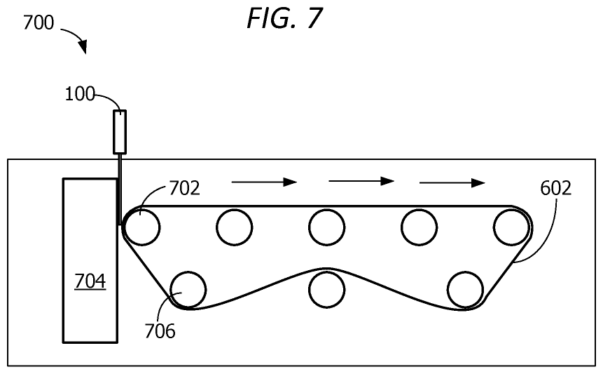

Referring now to FIG. 7, an exemplary diagram is provided illustrating a side view of a conveyor 700, for which a tool, such as the band replacement tool 100 in FIG. 1 may be used. Conveyor 700 includes, for example, upper rollers, such as roller 702, and lower rollers, such as roller 706. In order to remove and/or replace band 602 around a set of rollers on conveyor 700, band replacement tool 100 may be used. When properly installed around the rollers, the band 602 in this example moves along the rollers in a left to right direction, as shown by the directional indicators in FIG. 7.

In this example, the shaft of band replacement tool 100 and the head are sized to fit between a roller 702 and the side wall 704 of the conveyor 700. The band replacement tool 100 is also sized to fit between a roller and a roller guide and between two rollers, for example. The band replacement tool 100 also includes a shaft having sufficient length to reach an underside of a roller 706 at the bottom of the set of rollers for conveyor 700.

### ADDITIONAL EXAMPLES

In some examples, the band replacement tool includes a head designed to fit around a band and push it back onto a roller. The head fits within a narrow space between the roller and the side of the conveyor. The tool includes a long shaft providing improved reach. A hole in the handle permits the tool to hang on a hook. A T-shaped handle provides greater leverage for the user.

In an example scenario, an unloader is used to unload trucks in the backroom of store or warehouse. The unloader includes a conveyor having a band wrapped around rollers that helps move the boxes of goods unloaded off the trucks. The band sometimes pops off the rollers. The band replacement tool is sized to fit the band, fit between the rollers, and fit between the rollers and the side(s) of the conveyor. The tool helps a user to put the band back on quickly or replace a broken band with a new band.

In some examples, the head of the band replacement tool is the same or substantially the same width as the band itself. This enables the head of the tool to fit between the rollers and the sides of the conveyor device.

In other examples, the curved end of the tool is sized to fit within the guides of each roller. The guides on the rollers form a channel along the tops and/or bottoms of the rollers. The band is stretched over the rollers and positioned within this channel. The tool is sized to securely cup the band within the head of the tool while reaching around and under the rollers. This permits the user to push the band into place within the guides of each roller easily and quickly while minimizing accidents.

In other examples, the handle is a T-shape, L-shape or rectangular shape providing a better grip and more leverage than other tools. The finger grips provide protection to the user's knuckles. This protects the user's hand if the tool slips.

The band replacement tool in still other examples is a user-friendly tool that enables a user to replace a band within thirty seconds or less repair time. The personnel at a store or warehouse are able to replace the bands without assistance from technicians. The safety handle prevents accidents. Likewise, the tool head is sized to avoid damaging equipment by cupping the band during installation.

In yet other examples, the dimensions of the band replacement tool enable the user to effectively perform the task of replacing the bands which drive the conveyor sorting modules in a conveyor system. In this example, the tool head fits into the groove for routing bands. The tool cups the band during installation. The safety handle helps prevent accidents, making the tool a cost-effective solution for replacing bands on conveyor devices.

Alternatively, or in addition to the other examples described herein, examples include any combination of the following:
a shaft comprising a first end and a second end, the shaft having a threshold minimum length and a threshold maximum width;
a head connected to the first end of the shaft, the head comprising a concave surface disposed between a first side member and a second side member forming a U-shaped end sized to cup a portion of a band at least partially during installation of the band around a set of rollers;
a gripping member comprising a set of finger grips for grasping the band replacement tool during the installation of the band;
wherein the threshold minimum length of the shaft is a length that is equal to or greater than seven inches;
wherein the threshold maximum width of the shaft is a width that is less than or equal to five-eighths of an inch;
wherein the gripping member further comprises a cylindrical handle;
wherein the gripping member further comprises a rectangular handle;
wherein the gripping member further comprises a T-shaped handle;
wherein the gripping member further comprises an opening within a handle of the gripping member for hanging the tool;
wherein the head is sized to fit within a groove for routing the band around the set of rollers of the conveyor device;
wherein the head is sized to fit within a groove formed by two rollers, wherein the head fits between the two rollers on the conveyor device; and
wherein the head is sized to fit within a space between a roller and a side of a conveyor device.

While the aspects of the disclosure have been described in terms of various examples with their associated operations, a person skilled in the art would appreciate that a combination of operations from any number of different examples is also within scope of the aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of” “only one of” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A tool comprising:
a shaft comprising a first end and a second end;
a head connected to the first end of the shaft, the head comprising a concave surface disposed between a first side member and a second side member forming a U-shaped end sized to cup a portion of a band; and
a gripping member connected to the second end of the tool.

2. The tool of claim 1, wherein a length of the shaft is equal to or greater than a threshold minimum length.

3. The tool of claim 1, wherein a width of the shaft is equal to or less than a threshold maximum width.

4. The tool of claim 1, wherein the gripping member further comprises a cylindrical handle.

5. The tool of claim 1, wherein the gripping member further comprises a rectangular handle.

6. The tool of claim 1, wherein the gripping member further comprises a T-shaped handle.

7. The tool of claim 1, wherein the gripping member further comprises an
opening within the gripping member for hanging the tool.

8. The tool of claim 1, wherein the head is sized to fit within a groove formed by two rollers of a conveyor device.

9. The tool of claim 1, wherein the head is sized to fit within a space between a roller and a side of a conveyor device.

10. A band replacement apparatus comprising:
a gripping member;
a shaft having a first end connected to the gripping member; and
a head connected to a second end of the shaft, the head comprising a concave surface disposed between a set of side members of the head forming a substantially U-shaped end of the head.

11. The band replacement apparatus of claim 10, wherein a length of the shaft is equal to or greater than a minimum threshold length.

12. The band replacement apparatus of claim 10, wherein a width of the shaft is less than or equal to a maximum threshold width.

13. The band replacement apparatus of claim 10, wherein the gripping member further comprises:
a T-shaped handle including a set of finger grips disposed along a side of the T-shaped handle.

14. The band replacement apparatus of claim 10, wherein the gripping member further comprises:
a rectangular-shaped handle including a set of finger grips disposed along a side of the rectangular-shaped handle.

15. The band replacement apparatus of claim 10, wherein the gripping member further comprises:
a cylindrical handle including a set of finger grips disposed along an exterior length of the cylindrical handle.

16. The band replacement apparatus of claim 10, wherein the head is sized to fit within a groove for routing a band around a set of rollers of a conveyor device.

17. The band replacement apparatus of claim 10, wherein the head is sized to fit between two rollers on a conveyor device.

18. A band replacement tool comprising:
a shaft comprising a first end and a second end, the shaft having a threshold minimum length and a threshold maximum width, wherein the shaft is sized to fit between a roller of a conveyor device and a side member of the conveyor device, and wherein the threshold minimum length is a length sufficient to reach a lower roller on the conveyor device;
a head connected to the first end of the shaft, the head comprising a concave surface disposed between a first side member and a second side member forming a U-shaped end sized to partially enclose a portion of a band during installation of the band around a set of rollers, wherein the head is sized to fit within a groove for routing the band around the roller of the conveyor device; and
a rectangular-shaped handle comprising a set of finger grips disposed along an interior side of the rectangular-shaped handle and an opening embedded within a portion of the rectangular-shaped handle.

19. The band replacement tool of claim 18, wherein the maximum threshold width of the shaft is a length that is greater than or equal to five-eighths of an inch.

20. The band replacement tool of claim 18, wherein the minimum threshold length of the shaft is a width that is less than or equal to seven inches.
